(19) United States
(12) Patent Application Publication
(10) Pub. No.: US 2008/0079928 A1
(43) Pub. Date: Apr. 3, 2008

(54) System and method for designing an optical element

(75) Inventors: Daniel G. Smith, Oro Valley, AZ (US); David M. Williamson, Tuscon, AZ (US)

Correspondence Address: Roeder & Broder LLP, 5560 Chelsea Avenue, La Jolla, CA, 92037, US

(73) Assignee: Nikon Corporation, Tokyo (JP)

(21) Appl. No.: 11/904,809

(22) Filed: Sep. 28, 2007

Related U.S. Application Data
(60) Provisional application No. 60/848,161, filed on Sep. 29, 2006.

(51) Int. Cl. G03B 41/00; G02B 27/64

(52) U.S. Cl. 355/77; 356/124

(57) ABSTRACT

A method for designing, an optical assembly (16) for transmitting an illumination beam (334) includes the steps of selecting an optical element (32), selecting at least two rays (356) from the illumination beam (334), and calculating a contrast of the at least two rays (356) that exit the optical element (32) based on the at least two rays (356). With this design, one or more parameters of the optical element (32) can be adjusted and the contrast recalculated until the performance characteristics of the optical element (32) are optimized. For example, the optical element (32) can include a crystalline first optical component (350) and a crystalline second optical component (352) that are stacked on each other and that are rotated relative to each other a rotation angle (358). The first optical component (350) has a FOC thickness (360) and a FOC entry curvature (362) and the second optical component (352) has a SOC thickness (366) and a SOC entry curvature (368). With this design, the parameters can include adjusting the rotation angle (358), the FOC thickness (360) and the FOC entry curvature (362), the SOC thickness (366) and/or the SOC entry curvature (368). The step of calculating contrast can include the step of using the following formula,

$$V ≡ 1 - \frac{{A}_{p}^{s}}{{A}_{s}^{2} + {A}_{p}^{2}} 2 {Sin}^{2} θ$$

wherein V is the contrast, Aₛ is an estimated amplitude of the s-polarization in the at least two rays (356) that exit the optical element, Aₚ is an estimated amplitude of the p-polarization in the at least two rays (356) that exit the optical element, and θ is the angle of incidence of the at least two rays (356).

### RELATED APPLICATION

This application claims priority on U.S. Provisional Application No. 60/848,161 filed on Sep. 29, 2006 and entitled “Intrinsic Birefringence Compensated for Minimum Contrast”. The contents of U.S. Provisional Application No. 60/848,161 are incorporated herein by reference.

### BACKGROUND

Exposure apparatuses are commonly used to transfer images from a reticle onto a semiconductor wafer during semiconductor processing. A typical exposure apparatus includes an illumination source that generates an illumination beam, a reticle stage assembly that positions a reticle, an optical assembly that includes a plurality of optical elements, and a wafer stage assembly that positions a semiconductor wafer. The features of the images transferred onto the wafer from the reticle with the exposure apparatus are extremely small.

Recently, exposure apparatuses have been developed that use fluid positioned between a last optical element of the optical assembly and the wafer. These types of systems are commonly referred to as immersion exposure apparatuses. These systems use an illumination beam having a relatively short wavelength.

Typically, imaging requires that the polarization of the illumination beam is just right otherwise a contrast of illumination beam that is directed onto the wafer is reduced. Generally speaking, s-polarization is preferred over p-polarization. Thus, the illumination source is typically designed to generate an illumination beam that is all s-polarization.

With immersion exposure apparatuses that use an illumination beam having a relatively short wavelength, it is desirable that the last optical element have a relatively high numerical aperture. In order to achieve a relatively high numerical aperture, it is necessary that the material used in the last optical element have a relatively large angle of incidence and index of refraction at the wavelength of the illumination beam. One type of material that has a relatively large index of refraction is also a cubic crystal. Unfortunately, at relatively short wavelengths of light, the crystal exhibits intrinsic birefringence. Stated in another fashion, the crystal birefringence changes the polarization of light that is at a relatively short wavelength. In this example, the intrinsic birefringence of the crystal will change at least a portion of the s-polarization of the illumination beam to the less desirable p-polarization. As a result thereof, the contrast of images directed onto the wafer are reduced.

### SUMMARY

The present invention is a method for designing an optical assembly for transmitting an imaging beam. In one embodiment, the method includes the steps of selecting an optical element, selecting at least two rays from the imaging beam, and calculating a contrast of the at least two rays that exit the optical element. With this design, one or more design parameters of the optical element can be adjusted, and the contrast recalculated until the performance characteristics of the optical element are optimized.

In one embodiment, the step of selecting an optical element includes selecting an optical element that is made of a high index crystalline material. For example, the optical element can be made of Barium Lithium Fluorine. This type of material has a relatively high index of refraction and relatively high transmission. These are desirable features for a last optical element of the optical assembly.

Alternatively or additionally, the step of selecting an optical element can include selecting an optical element having a first optical component and a second optical component placed adjacent to each other. In this embodiment, the first optical component has a FOC thickness and a FOC entry curvature. Further, the second optical component has a SOC thickness and a SOC entry curvature. Moreover, the optical components are rotated relative to each other a rotation angle.

As provided herein, the step of calculating a contrast can include calculating a contrast for a number of alternative optical element designs in which at least one of (i) the FOC thickness, (ii) the FOC entry curvature, (iii) the SOC thickness, and (iv) the SOC entry curvature are adjusted. Further, the step of calculating a contrast can include calculating a contrast for a number of alternative optical element designs in which at least two of (i) the FOC thickness, (ii) the FOC entry curvature, (iii) the SOC thickness, and (iv) the SOC entry curvature are adjusted.

Alternatively or additionally, the step of calculating a contrast can include calculating a contrast for a number of alternative optical element designs in which the first optical component is rotated at different rotation angles relative to the second optical component.

Further, the step of calculating contrast can include the step of calculating an amplitude of the s-polarization for at least two rays, and calculating an amplitude of the p-polarization for at least two rays. Moreover, the step of calculating contrast can include using the following formula,

$$V ≡ 1 - \frac{{A}_{p}^{s}}{{A}_{s}^{2} + {A}_{p}^{2}} 2 {Sin}^{2} θ$$

wherein V is the contrast, Aₛ is an estimated amplitude of the s-polarization in the at least two rays that exit the optical element, Aₚ is an estimated amplitude of the p-polarization of at least two rays that exit the optical element, and θ is the angle of incidence of at least two rays.

In yet another embodiment, the step of selecting at least two rays includes selecting two rays that have approximately the same angle of incidence and passing through opposite sides of the pupil. Further, (i) the step of selecting at least two rays can include the step of selecting a plurality of ray pairs, with each of rays in the ray pairs having approximately the same angle of incidence and passing through opposite sides of the pupil, and (ii) wherein the step of calculating a contrast includes calculating a contrast for each of the ray pairs.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1A is a schematic illustration of an exposure apparatus having features of the present invention;

FIG. 1B is a polarization pupil map that illustrates s-polarization for an illumination beam having features of the present invention;

FIG. 2 is a simplified side illustration of a final optical elements of a lithographic imaging lens having features of the present invention, a wafer, a glass plate, and an immersion fluid;

FIG. 3A is a simplified side view of the optical element of FIG. 2, a wafer, and an illumination beam;

FIG. 3B is a simplified top view of the optical element of FIG. 3A;

FIG. 4 is a polarization pupil map that illustrates the polarization of the illumination beam after having passed through a one piece optical element; and

FIG. 5 is a simplified graph that illustrates irradiance.

### DESCRIPTION

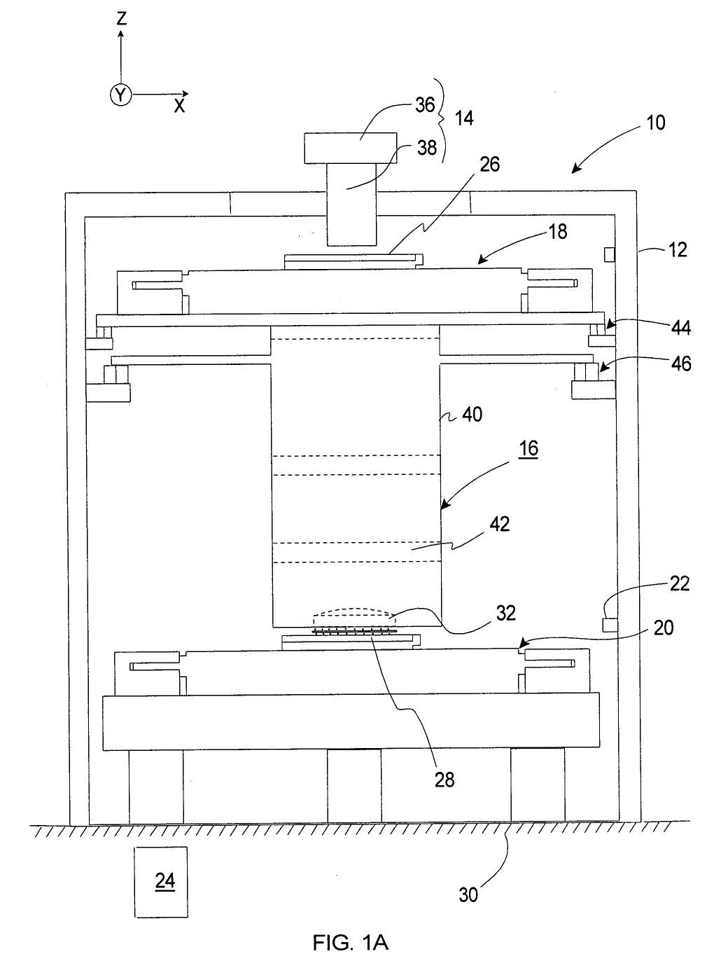

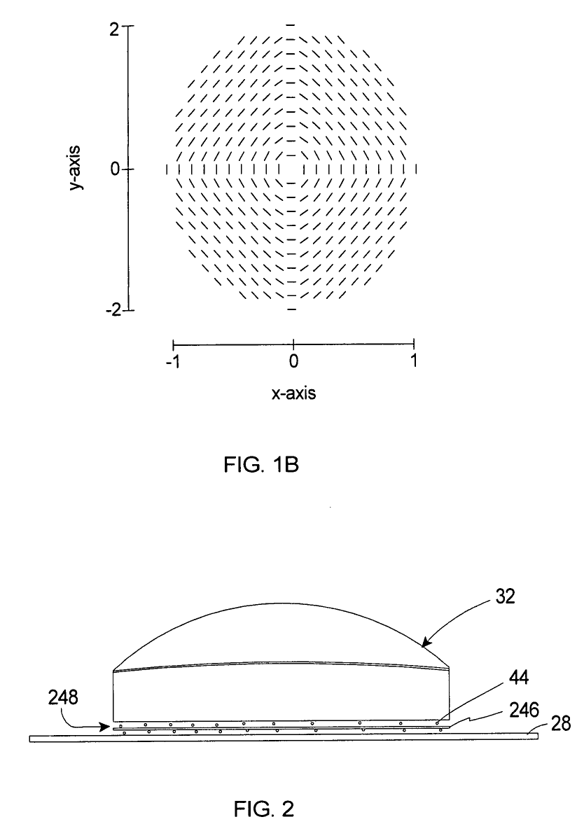

FIG. 1A is a schematic illustration of a precision assembly, namely an exposure apparatus 10 having features of the present invention. The exposure apparatus 10 includes an apparatus frame 12, an illumination system 14 (irradiation apparatus), an optical assembly 16, a reticle stage assembly 18, a wafer stage assembly 20, a measurement system 22, and a control system 24. The design of the components of the exposure apparatus 10 can be varied to suit the design requirements of the exposure apparatus 10.

The exposure apparatus 10 is particularly useful as a lithographic device that transfers a pattern (not shown) of an integrated circuit from a reticle 26 onto a semiconductor wafer 28. The exposure apparatus 10 mounts to a mounting base 30, e.g., the ground, a base, or floor or some other supporting structure.

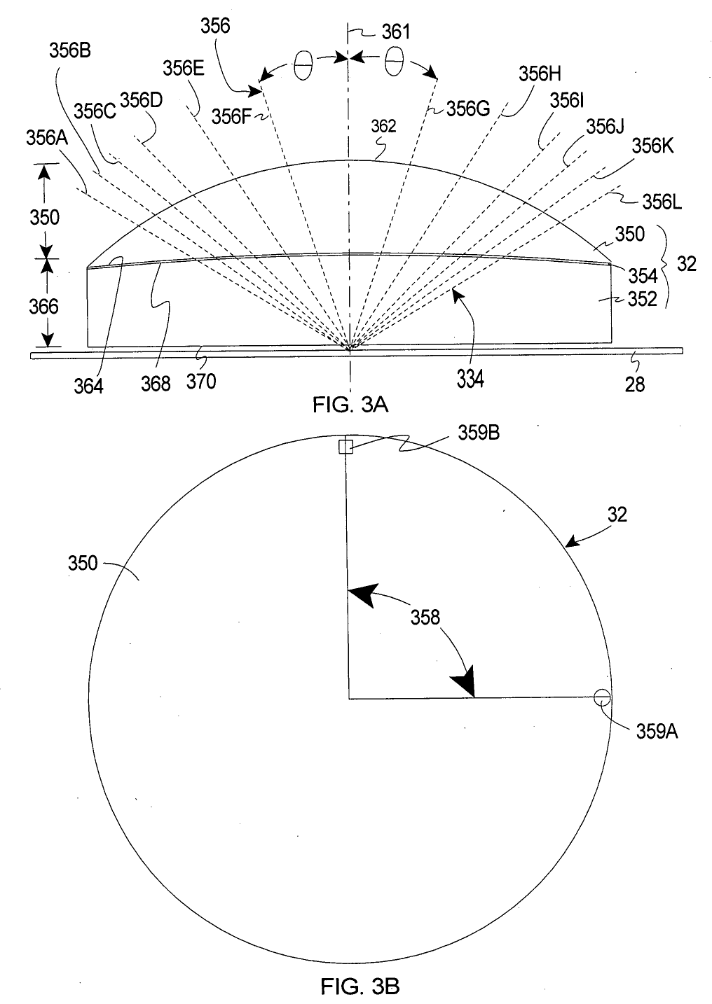

As an overview, in certain embodiments, the present invention provides one or more unique methods for designing a last optical element 32 (illustrated in phantom) in the optical assembly 16. In certain embodiments, with the unique methods disclosed herein, the last optical element 32, having a high index of refraction, can be designed to have a relatively high numerical aperture, a relatively large angle of incidence. Further, the present invention provides one or more methods to determine and reduce the influence of the intrinsic birefringence of a crystal optical element 32. Moreover, the present invention provides a method to design the last optical element 32 so that an illumination (imaging) beam 334 (illustrated in FIG. 3A) that is transmitted through the last optical element 32 has very good contrast. As a result thereof, the exposure apparatus 10 can be used to manufacture higher density wafers.

There are a number of different types of lithographic devices. For example, the exposure apparatus 10 can be used as a scanning type photolithography system that exposes the pattern from the reticle 26 onto the wafer 28 with the reticle 26 and the wafer 28 moving synchronously. Alternatively, the exposure apparatus 10 can be a step-and-repeat type photolithography system that exposes the reticle 26 while the reticle 26 and the wafer 28 are stationary.

The apparatus frame 12 is rigid and supports the components of the exposure apparatus 10. The apparatus frame 12 illustrated in FIG. 1 supports the reticle stage assembly 18, the optical assembly 16 and the illumination system 14 above the mounting base 30.

The illumination system 14 includes an illumination source 36 and an illumination optical assembly 38. The illumination source 36 emits an illumination beam (irradiation) of light energy. The illumination optical assembly 38 guides the beam of light energy from the illumination source 36 to the reticle 26. In one embodiment, a portion the beam is transmitted through the reticle 26 and focused on the wafer 28 with the optical assembly 16. Alternatively, for example, the light energy can be directed at the bottom of the reticle 26 and the light energy reflected off of the reticle 26 can be focused on the wafer 28 with the optical assembly 16.

The illumination source 36 can be a KrF excimer laser (248 nm), an ArF excimer laser (193 nm) or a F₂ laser (157 nm). Alternatively, the illumination source 36 can generate charged particle beams such as an x-ray or an electron beam. In one non-exclusive embodiment, the illumination beam 334 is at a wavelength of between approximately 157 nm and 248 nm.

Typically, imaging requires that the polarization of the illumination beam 334 is just right otherwise the contrast and quality of the image transferred onto the wafer 28 is reduced. Generally speaking, s-polarization of the illumination beam 334 is preferred over p-polarization of the illumination beam 334. Thus, the illumination source 14 is typically designed to generate an illumination beam 334 that is all s-polarization. FIG. 1B is a polarization pupil map that illustrates a polarization of one embodiment of the illumination beam generated by the illumination system 14. In this embodiment, the polarization of the illumination beam is purely s-polarization. In certain embodiments, it is assumed that the illumination beam travels through reticle 26 and to the entrance of the last optical element without a change in polarization. Stated in another fashion, in certain embodiments, the illumination beam 334 that enters the last optical element 32 has purely s-polarization.

Referring back to FIG. 1A, the optical assembly 16 projects and/or focuses the light from the reticle 26 onto the wafer 28. Depending upon the design of the exposure apparatus 10, the optical assembly 16 can magnify or reduce the image from the reticle 26. The optical assembly 16 need not be limited to a reduction system. It could also be a 1× or magnification system.

In one embodiment, the optical assembly 16 includes an optical housing 40 and a plurality of other optical elements 42 (only three other elements are illustrated in phantom) in addition to the last optical element 32. In this embodiment, the optical housing 40 retains the other optical elements 42 and the last optical element 32. Further, the other optical elements 42 are only illustrated in FIG. 1 for reference and do not to depict any particular orientation and/or number of necessary lenses.

In the design illustrated in FIG. 1A, the last optical element 32 is the lowest optical element, and is the last optical element of the optical assembly 16 in which the illumination beam 334 will be transmitted prior to exiting the optical assembly 16.

The design and method for designing the last optical element 32 is described in more detail below.

When DUV light such as from an excimer laser is used, glass materials such as quartz and fluoride that transmit DUV rays can be used in the other optical elements 42 of the optical assembly 16. When the ArF or F₂ type laser is used, the optical assembly 16 can be either catadioptric or refractive.

The reticle stage assembly 18 holds and positions the reticle 26 relative to the optical assembly 16 and the wafer 28. Somewhat similarly, the wafer stage assembly 20 holds and positions the wafer 28 with respect to the projected image of the illuminated portions of the reticle 26.

The measurement system 22 monitors movement of the reticle 26 and the wafer 28 relative to the optical assembly 16 or some other reference. With this information, the control system 24 can control the reticle stage assembly 18 to precisely position the reticle 26 and the wafer stage assembly 20 to precisely position the wafer 28. For example, the measurement system 22 can utilize multiple laser interferometers, encoders, and/or other measuring devices.

The control system 24 is connected to the reticle stage assembly 18, the wafer stage assembly 20, and the measurement system 22. The control system 24 receives information from the measurement system 22 and controls the stage mover assemblies 18, 20 to precisely position the reticle 26 and the wafer 28. The control system 24 can include one or more processors and circuits.

A photolithography system (an exposure apparatus) according to the embodiments described herein can be built by assembling various subsystems, including each element listed in the appended claims, in such a manner that prescribed mechanical accuracy, electrical accuracy, and optical accuracy are maintained. In order to maintain the various accuracies, prior to and following assembly, every optical system is adjusted to achieve its optical accuracy. Similarly, every mechanical system and every electrical system are adjusted to achieve their respective mechanical and electrical accuracies. The process of assembling each subsystem into a photolithography system includes mechanical interfaces, electrical circuit wiring connections and air pressure plumbing connections between each subsystem. Needless to say, there is also a process where each subsystem is assembled prior to assembling a photolithography system from the various subsystems. Once a photolithography system is assembled using the various subsystems, a total adjustment is performed to make sure that accuracy is maintained in the complete photolithography system. Additionally, it is desirable to manufacture an exposure system in a clean room where the temperature and cleanliness are controlled.

In one embodiment, the exposure apparatus 10 is an immersion type lithography system that utilizes an immersion fluid 44 (illustrated as small dots) positioned between the last optical element 32 and the wafer 28.

FIG. 2 is a simplified side illustration of the last optical element 32 the wafer 28, the immersion fluid 44, and a glass plate 246. In this embodiment, a gap 248 between the last optical element 32 and the wafer 28 is filled with the immersion fluid 44 and the glass plate 246. A non-exclusive examples of suitable immersion fluids 44 includes highly purified water and JSR HIL-1.

FIG. 3A is a simplified side view of one embodiment of the last optical element 32, the wafer 28, and a portion of the illumination beam 334; and FIG. 3B is a simplified top view of the last optical element 32. In this embodiment, the last optical element 32 includes a first optical component 350, a second optical component 352, and a filler 354 that fills the gap between the optical components 350, 352. Alternatively, the last optical element 32 can be designed with more than two stacked optical components 350, 352.

In FIG. 3A, the first optical component 350 is stacked on top of the second optical component 352. With this design, the illumination beam 334 (i) enters the first optical component 350, (ii) is transmitted through the first optical component 350 to the filler 354, (iii) is transmitted through the filler 354 to the second optical component 352, and (iv) is transmitted through the second optical component 352 to the wafer 28.

In one embodiment, each of the optical components 350, 352 is generally symmetrical disk shaped. Alternatively, one or both of the optical components 350, 352 can be asymmetrical or have another shape.

Further, in one embodiment, each of the optical components 350, 352 is made of a crystal material. Crystal materials have a relatively high numerical aperture (between approximately 1.56 and 2.1), a relatively large angle of incidence (between approximately 65° and 75°), and relatively high transmission (above approximately 095/cm) at the wavelength of the illumination beam 334. Non-exclusive examples of suitable crystal materials include Barium Lithium Flouride (BaLiF) and Lutatium Aluminum Garnette (LuAG).

At relatively short wavelengths, (e.g. wavelengths in the range of between approximately 248 nm and 157 nm) these cubic crystal materials have intrinsic birefringence. As a result thereof, at these wavelengths, the crystal changes the polarization of illumination beam 334 that travels through the last optical element 32. In this example, the intrinsic birefringence of the crystal will change the s-polarization of the illumination beam 334 to the less desirable p-polarization.

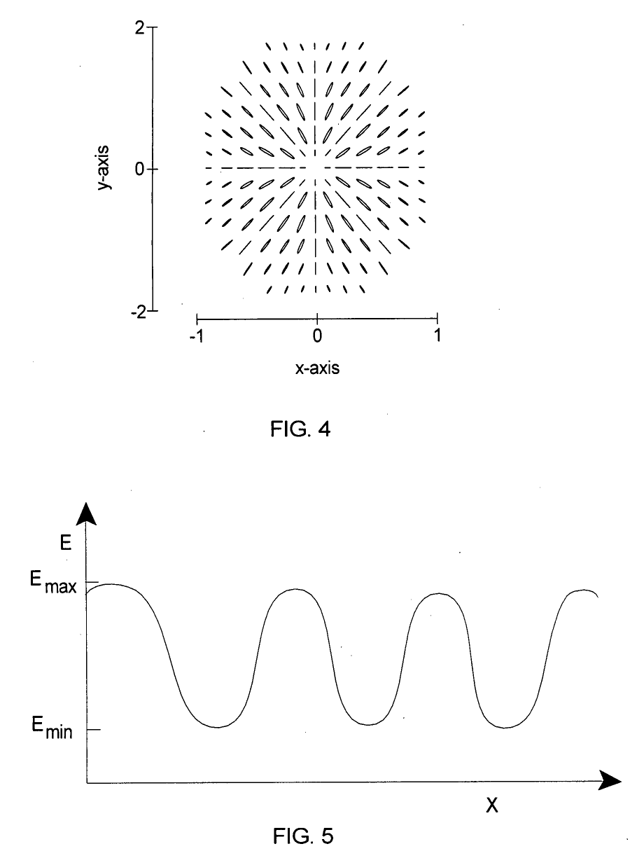

FIG. 4 is a polarization pupil map that illustrates the polarization of the illumination beam that has been transmitted through a one piece, crystal optical element (not shown). FIG. 4 illustrates that the polarization of the illumination beam that has been transmitted through the one piece, crystal optical element is different from that illustrated in FIG. 1B. More specifically, FIG. 1B illustrates the polarization entering the one-piece crystal optical element is purely s-polarization, while FIG. 4 illustrates that the polarization has been changed to p-polarization and circular polarization after being transmitted through the one piece, crystal optical element. This mixture of p-polarization and circular polarization results in low contrast and low quality of the features in the images being transferred to the wafer 28. FIG. 4 also illustrates that with the crystal materials described above, the amount of polarization is changed by the crystal material depends upon the location in which the illumination beam travels through the crystal material. Stated in another fashion, the amount of birefringence will depend upon the location and angle of incidence of the rays 356 (illustrated in FIG. 3A) entering the last optical element 32.

Referring back to FIGS. 3A and 3B, the illumination beam 334 is represented by a plurality of rays 356 (only a few are illustrated in FIG. 3A) that are directed into the last optical element 32 at different angles of incidence θ relative to the surface of the wafer 28. Moving left to right in FIG. 3A, the rays 356 have been labeled 356A-356L. With the crystal materials described above, the amount of birefringence will depend upon the wavelength of the illumination beam 334, the crystal material utilized, the thickness of the crystal, and the location and angle of incidence of the rays 356 entering the last optical element 32. For example, ray 356A will experience a different level of birefringence than ray 356B because ray 356A has a different angle of incidence than ray 356B and they travel through different portions of the last optical element 32.

As provided above, the present invention provides one or more methods to determine and reduce the influence of the intrinsic birefringence of the last optical element 32 on the illumination beam 334. As a result thereof, the present invention provides a method to design the last optical element 32 so that the illumination beam 334 transmitted through the last optical element 32 to the wafer 28 has very good contrast.

In one embodiment, in order to reduce the influence of the intrinsic birefringence of the last optical element 32, the optical components 350, 352 are rotated (clocked) relative to each other a rotation angle 358 (illustrated in FIG. 3B). Stated in another fashion, because the level of birefringence of the crystal depends on the location in which the rays 356 enter the crystal, the optical components 350, 352 are rotated relative to each other. In FIG. 3B, a circle 359A represents the position of the first optical component 350 while a square 359B represents the position of the second optical component 352.

With the optical components 350, 352 being rotated relative to each other, each individual ray 356 will experience a first level of birefringence as it travels through the first optical component 350, and a second level of birefringence as it travels through the second optical component 352. As a result thereof, the rotation angle 358 can be varied to optimize the level of birefringence that is experienced by the rays 356. For example, the rotation angle 358 can be approximately ninety (90) degrees as illustrated in FIG. 3B. Alternatively, in other non-exclusive examples, the rotation angle 358 can be approximately forty-five (45), sixty (60) degrees, angles less than 45, angles greater than 90, or angles between 45 and 90 degrees.

The size and shape of each of the optical components 350, 352, will influence the distance that each of the rays 356 travels through each of the optical components 350, 352. As a result thereof, the size and shape of each of the optical components 350, 352, will influence the level of birefringence experienced by each of rays 356. Referring to FIG. 3A, (i) the first optical component 350 includes a FOC thickness 360 along a center axis 361, a FOC entry curvature 362 at which the illumination beam 334 enters the first optical component 350, and a FOC exit curvature 364 from which the illumination beam 334 exits the first optical component 350; and (ii) the second optical component 352 includes a SOC thickness 366 along the center axis 361, a SOC entry curvature 368 at which the illumination beam 334 enters the second optical component 350, and a flat SOC exit surface 370 from which the illumination beam 334 exits the second optical component 352. Typically, the FOC exit curvature 364 is the same as the SOC entry curvature 368.

With the present invention, the level of birefringence experienced by each of the rays 356 can be adjusted by adjusting (i) the FOC thickness 360, (ii) the FOC entry curvature 362, (iii) the SOC thickness 366, and/or (iv) the FOC exit curvature 364 and the SOC entry curvature 368.

The design of the filler 354 can be varied to provide good transmission of the rays 356. Non-exclusive examples of suitable fillers 354 include a thin layer of liquid such as immersion fluid 44 described above.

The present invention provides a method to optimize the design of the last optical element 32. For example, the present invention provides a method to estimate the contrast for at least two rays 356 that are transmitted through the last optical element 32. Stated in another fashion, the rays 356 are traced as they pass through the last optical element 32 to determine the contrast for those rays 356. With this method, one or more design parameters of the optical element 32 can be adjusted, and the contrast recalculated until the performance characteristics of the optical element 32 are optimized.

A non-exclusive list of the design parameters that can be adjusted include (i) the material utilized in the optical components 350, 352, (ii) the magnitude of the rotation angle 358, (iii) the FOC thickness, (iv) the FOC entry curvature, (v) the SOC thickness, and (vi) the SOC entry curvature. With this method, one, two, three, four, or more of these design parameters can be adjusted, and the contrast recalculated until the performance characteristics of the optical element 32 are acceptable.

In one non-exclusive example, (i) the FOC entry curvature is convex and is between approximately 0 to 1/30 millimeters, (ii) the SOC entry curvature is between approximately − 1/30 to 1/30 millimeters, and (iii) the overall thickness of the two optical components 350, 352 is between approximately 10 millimeters and 200 millimeters.

In one embodiment, for each proposed design, the contrast for a plurality of alternative ray pairs, spread throughout the possible angles of incidence, is calculated to get a better idea of the overall influence of the last optical element 32. For example, for each proposed design, the contrast for a grid of 5, 10, 20, 30, 40, 50, 60, 80, 100, 200, or more ray pairs can be calculated. In certain embodiments, the formulas described herein only apply to dense line spaces at the resolution limit under coherent off-axis illumination. However, these examples can give an indication of the overall performance of the last optical element 32.

In certain embodiments, for each of the ray pairs, the two rays 356 in that ray pair are coherent, symmetric, and have approximately equal angles of incidence relative to the wafer (surface normal). In the embodiment illustrated in FIG. 3A, (i) rays 356A and 356L form a ray pair that have the same angle of incidence; (ii) rays 356B and 356K form a ray pair that have the same angle of incidence; (iii) rays 356C and 356J form a ray pair that have the same angle of incidence; (iv) rays 356D and 356I form a ray pair that have the same angle of incidence; (v) rays 356E and 356H form a ray pair that have the same angle of incidence; and (vi) rays 356F and 356G form a ray pair that have the same angle of incidence. In this example, for each proposed design, the fringe contrast for a plurality of six alternative interference ray pairs, is calculated to get an indication of the overall influence of the last optical element 32. Stated in another fashion, in this example, the interference of two plane waves from non-normal incidence is calculated.

Alternatively, the formulas can be expanded to three beam interference or more.

As provided herein, for two rays, the irradiance E at the wafer 28 can be calculated as follows:

$$E = 2 ( {A}_{s}^{2} + {A}_{p}^{2} ) + 2 ⌊ {A}_{s}^{2} + ( Cos 2 θ ) {A}_{p}^{S} ⌋ Cos ( \frac{4 n}{λ} x Sin θ ) \qquad Eq . 1$$

where Aₛ is an estimated amplitude of the s-polarization in the at least two rays that exit the optical element, Aₚ is an estimated amplitude of the p-polarization in the at least two rays that exit the optical element, θ is the angle of incidence of the rays in the ray pair, λ is the wavelength of the illumination beam 334 in the last optical element 32, and n is above 1.56.

It is known that

Cos 2θ=(1−2 Sin²θ) Eq. 2

As a result thereof, Eq. 1 can be re-expressed as follows:

$$E = 2 ( {A}_{s}^{2} + {A}_{p}^{2} ) + 2 ⌊ {A}_{s}^{2} + ( 1 - 2 {Sin}^{2} θ ) {A}_{p}^{S} ⌋ Cos ( \frac{4 n}{λ} x Sin θ ) \qquad Eq . 3$$

FIG. 5 illustrates a non-exclusive example, of the irradiance E relative to the position for the optical element. In this example, the irradiance E is a sine wave that has a maximum irradiance (“E max”) and a minimum irradiance (“E min”).

As a result thereof, the contrast V can be calculated as follows:

$$V ≡ \frac{{E}_{max} - {E}_{min}}{{E}_{max} + {E}_{min}} ≡ \frac{{A}_{s}^{2} + ( 1 - 2 {Sin}^{2} θ ) {A}_{p}^{2}}{{A}_{s}^{2} + {A}_{p}^{2}} = 1 - \frac{{A}_{p}^{s}}{{A}_{s}^{2} + {A}_{p}^{2}} 2 {Sin}^{2} θ \qquad Eq . 4$$

The closer the contrast V approaches value of one, the better the contrast and the better quality of the images that are being transferred to the wafer. Thus, referring to Eq. 4, contrast V improves as the portion

$$\frac{{A}_{p}^{2}}{{A}_{s}^{2} + {A}_{p}^{2}} 2 {Sin}^{2} θ \qquad$$

approaches zero. Thus, this portion of Eq. 4 can be coined the term “contrast reduction” CR and can be expressed as follows:

$$CR ≡ \frac{{A}_{p}^{2}}{{A}_{s}^{2} + {A}_{p}^{2}} 2 {Sin}^{2} θ \qquad Eq . 5$$

With this design, the contrast V becomes very good as the value of the contrast reduction” CR approaches zero.

Aₛ and Aₚ can be calculated for use in Eqs. 3-5 using the following:

$$( \begin{matrix}Cos φ & Sin φ \\ - Sin φ & Cos φ\end{matrix} ) ( \begin{matrix}JR 1 + iJI 1 & JR 2 + iJI 2 \\ JR 3 + iJI 3 & JR 4 + iJI 4\end{matrix} ) ( \begin{matrix}Cos φ & - Sin φ \\ Sin φ & Cos φ\end{matrix} ) ( \begin{matrix}0 \\ 1\end{matrix} ) = ( \begin{matrix}{A}_{P} \\ {A}_{S}\end{matrix} ) \qquad Eq . 6$$

In Eq. 6,

$$( \begin{matrix}JR 1 + iJI 1 & JR 2 + iJI 2 \\ JR 3 + iJI 3 & JR 4 + iJI 4\end{matrix} )$$

is a Jones matrix that estimates the polarization behavior of the rays in the last optical element,

$$( \begin{matrix}Cos φ & Sin φ \\ - Sin φ & Cos φ\end{matrix} ) ( \begin{matrix}Cos φ & - Sin φ \\ Sin φ & Cos φ\end{matrix} )$$

is used to rotate polarization into the s and p polarization coordinate system from the ray coordinate system, and

$$( \begin{matrix}0 \\ 1\end{matrix} )$$

represents that the polarization that is at the input to the last optical element is one hundred percent s-polarization and zero percent p-polarization.

While the particular method as herein shown and disclosed in detail is fully capable of obtaining the objects and providing the advantages herein before stated, it is to be understood that it is merely illustrative of the presently preferred embodiments of the invention and that no limitations are intended to the details of construction or design herein shown other than as described in the appended claims.

What is claimed is:

1. A method for designing an optical assembly for transmitting an illumination beam, the method comprising the steps of:
selecting an optical element;
selecting at least one pair of rays from the illumination beam; and
calculating a contrast for the at least one pair of rays at an exit of the optical element.

2. The method of claim 1 wherein the step of selecting an optical element includes selecting an optical element that is made of a crystalline material.

3. The method of claim 2 wherein the step of selecting an optical element includes selecting an optical element that is made of Barium Lithium Fluoride.

4. The method of claim 1 wherein the step of selecting an optical element includes selecting an optical element that includes a first optical component and a second optical component that are stacked on each other, the first optical component includes a FOC thickness and a FOC entry curvature, and the second optical component includes a SOC thickness and a SOC entry curvature.

5. The method of claim 4 wherein the step of calculating a contrast includes the steps of calculating a contrast for a number of alternative optical element designs in which at least one of (i) the FOC thickness, (ii) the FOC entry curvature, (iii) the SOC thickness, and (iv) the SOC entry curvature is adjusted.

6. The method of claim 4 wherein the step of calculating a contrast includes the steps of calculating a contrast for a number of alternative optical element designs in which at least two of (i) the FOC thickness, (ii) the FOC entry curvature, (iii) the SOC thickness, and (iv) the SOC entry curvature is adjusted.

7. The method of claim 6 wherein the step of calculating a contrast includes the steps of calculating a contrast for a number of alternative optical element designs in which the first optical component is rotated at a different rotation angle relative to the second optical component.

8. The method of claim 4 wherein the step of calculating a contrast includes the steps of calculating a contrast for a number of alternative optical element designs in which the first optical component is rotated at a different rotation angle relative to the second optical component.

9. The method of claim 1 wherein the step of calculating contrast includes the step of calculating an amplitude of the s-polarization in the at least one pair of rays, and calculating an amplitude of the p-polarization in the at least one pair of rays.

10. The method of claim 1 wherein the step of calculating contrast includes the step of using the following formula,
$$V ≡ 1 - \frac{{A}_{p}^{s}}{{A}_{s}^{2} + {A}_{p}^{2}} 2 {Sin}^{2} θ$$
wherein V is the contrast, Aₛ is an estimated amplitude of the s-polarization in the at least one ray that exits the optical element, Aₚ is an estimated amplitude of the p-polarization in the at least one pair of rays that exit the optical element, and θ is the angle of incidence of the at least one pair of rays.

11. The method of claim 10 wherein the step of selecting at least one pair of rays includes the step of selecting two rays that have approximately the same angle of incidence.

12. The method of claim 1 (i) wherein the step of selecting at least one pair of rays includes the step of selecting a plurality of ray pairs, (ii) wherein for each of the ray pairs, each of rays has approximately the same angle of incidence, and (iii) wherein the step of calculating a contrast includes calculating a contrast for each of the ray pairs.

13. A method for designing an optical assembly for transmitting an illumination beam, the method comprising the steps of:
selecting an optical element that is made of a crystalline material, the optical element including a first optical component and a second optical component that are stacked on each other, the first optical component including a FOC thickness and a FOC entry curvature, and the second optical component includes a SOC thickness and a SOC entry curvature;
selecting a plurality of ray pairs from the illumination beam, wherein each of rays in each ray pairs has approximately the same angle of incidence; and
calculating a contrast for each of the ray pairs near an exit of the optical element.

14. The method of claim 13 wherein the step of selecting an optical element includes selecting an optical element that is made of Barium Lithium Fluoride.

15. The method of claim 13 wherein the step of calculating a contrast includes the steps of calculating a contrast for a number of alternative optical element designs in which at least one of (i) the FOC thickness, (ii) the FOC entry curvature, (iii) the SOC thickness, and (iv) the SOC entry curvature is adjusted.

16. The method of claim 13 wherein the step of calculating a contrast includes the steps of calculating a contrast for a number of alternative optical element designs in which at least two of (i) the FOC thickness, (ii) the FOC entry curvature, (iii) the SOC thickness, and (iv) the SOC entry curvature is adjusted.

17. The method of claim 13 wherein the step of calculating a contrast includes the steps of calculating a contrast for a number of alternative optical element designs in which the first optical component is rotated at a different rotation angle relative to the second optical component.

18. The method of claim 13 wherein the step of calculating contrast includes the step of calculating an amplitude of the s-polarization in the plurality of ray pairs, and calculating an amplitude of the p-polarization in the plurality of ray pairs.

19. The method of claim 13 wherein the step of calculating contrast includes the step of using the following formula,
$$V ≡ 1 - \frac{{A}_{p}^{s}}{{A}_{s}^{2} + {A}_{p}^{2}} 2 {Sin}^{2} θ$$
wherein V is the contrast, Aₛ is an estimated amplitude of the s-polarization in the at least one ray that exits the optical element, Aₚ is an estimated amplitude of the p-polarization each of the ray pairs that exit the optical element, and θ is the angle of incidence of the each of the ray pairs.
